(19) United States
(12) Patent Application Publication
(10) Pub. No.: US 2026/0366627 A1
(43) Pub. Date: Nov. 19, 2026

(54) DIAPHRAGM, VALVE COMPRISING SAME, AND MANUFACTURING METHOD FOR DIAPHRAGM

(71) Applicant: FUJIKIN INCORPORATED, Osaka (JP)

(72) Inventors: Tomokazu HIROTA, Osaka (JP); Hiroyuki ITO, Osaka (JP)

(73) Assignee: FUJIKIN INCORPORATED, Osaka (JP)

(21) Appl. No.: 19/478,283

(22) PCT Filed: Mar. 7, 2024
(86) PCT No.: PCT/JP2024/008736

§ 371 Date: Oct. 24, 2025

(30) Foreign Application Priority Data
Apr. 28, 2023 (JP) 2023-074608

(51) Int. Cl. F16K 7/12

(52) U.S. Cl. CPC F16K 7/12

(57) ABSTRACT

A flat plate-shaped diaphragm includes a ring-shaped peripheral edge portion having a uniform thickness, a pressed portion located on an inner peripheral side of the peripheral edge portion so as to be pressed, and an elastic deformation portion located between the peripheral edge portion and the pressed portion so as to elastically deform when the pressed portion is pressed. The elastic deformation portion is formed to have a thickness smaller than thicknesses of the peripheral edge portion and the pressed portion.

### TECHNICAL FIELD

The present invention relates to a diaphragm, a valve including the same, and a method for manufacturing a diaphragm.

### BACKGROUND ART

JP 2007-016935 A discloses a valve including a flat plate-shaped diaphragm having a uniform thickness.

### SUMMARY OF INVENTION

However, in order to improve springiness of the diaphragm described in JP 2007-016935 A, it is considered to reduce an overall thickness of the diaphragm, but in this case, a part of the diaphragm pressed by a diaphragm presser is likely to deform, and force transmission performance of the diaphragm is reduced. On the other hand, in order to improve the force transmission performance of the diaphragm described in JP 2007-016935 A, it is considered to increase the overall thickness of the diaphragm, but in this case, the springiness of the diaphragm is reduced.

The present invention has been made in view of this problem, and an object thereof is to provide a diaphragm excellent in both force transmission performance and springiness, a valve including the same, and a method for manufacturing a diaphragm.

An aspect of the present invention provides a flat plate-shaped diaphragm includes: a ring-shaped peripheral edge portion having a uniform thickness; a pressed portion located on an inner peripheral side of the peripheral edge portion so as to be pressed; and an elastic deformation portion located between the peripheral edge portion and the pressed portion so as to elastically deform when the pressed portion is pressed, wherein the elastic deformation portion is formed to have a thickness smaller than thicknesses of the peripheral edge portion and the pressed portion.

According to this aspect, a diaphragm excellent in sealing performance, force transmission performance, and springiness can be provided.

### BRIEF DESCRIPTION OF DRAWINGS

FIG. 1 is a diagram illustrating a valve according to the present embodiment.

FIG. 2 is an enlarged view illustrating a part A in FIG. 1, and illustrates the valve in a closed state.

FIG. 3 corresponds to FIG. 2, and illustrates the valve in an open state.

FIG. 4 is a perspective view illustrating a diaphragm according to the present embodiment.

FIG. 5 is a plan view illustrating the diaphragm according to the present embodiment.

FIG. 6 is a cross-sectional view taken along a line VI-VI in FIG. 5.

FIG. 7 is an enlarged view illustrating a part B in FIG. 6.

FIG. 8 is a plan view illustrating a diaphragm according to a first modification.

FIG. 9 is a cross-sectional view taken along a line IX-IX in FIG. 8.

FIG. 10 is a perspective view illustrating a diaphragm according to a second modification.

### DESCRIPTION OF EMBODIMENTS

Hereinafter, an embodiment of the present invention (hereinafter, referred to as the present embodiment) will be described with reference to the accompanying drawings. In the present specification, the same elements are denoted by the same reference numerals throughout the whole.

### Configuration of Valve

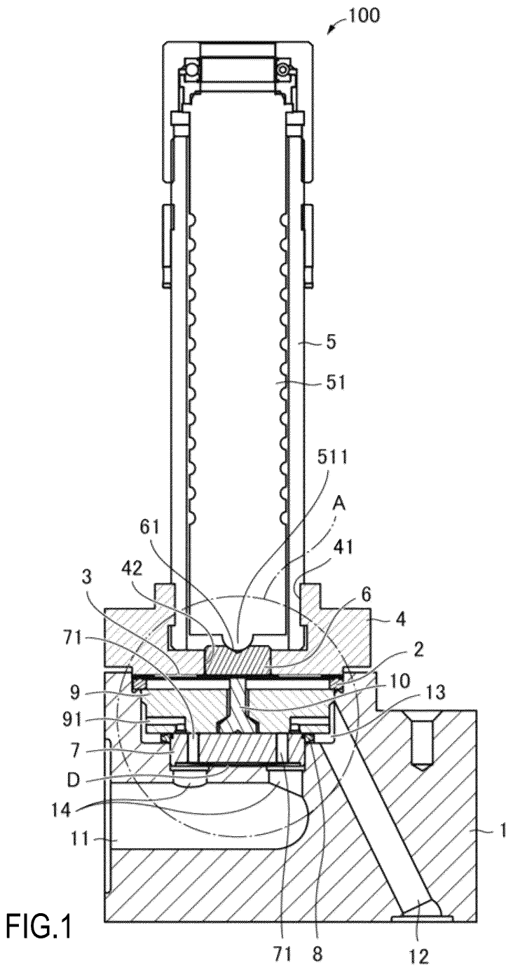

A valve 100 according to the present embodiment will be described with reference to FIGS. 1 to 3.

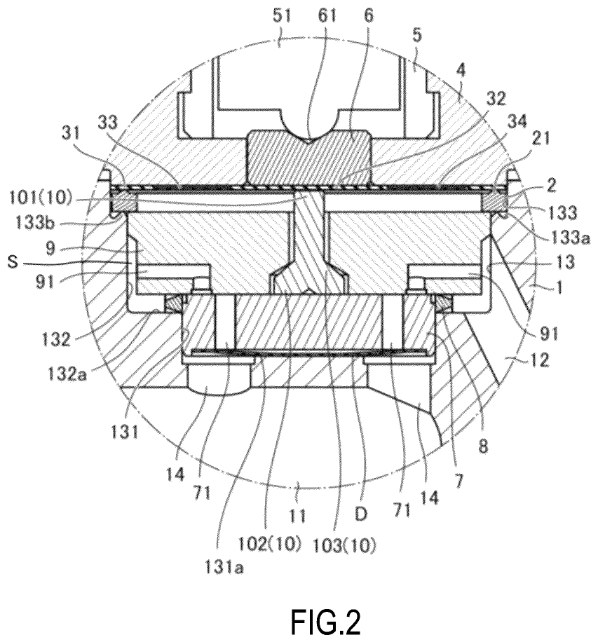

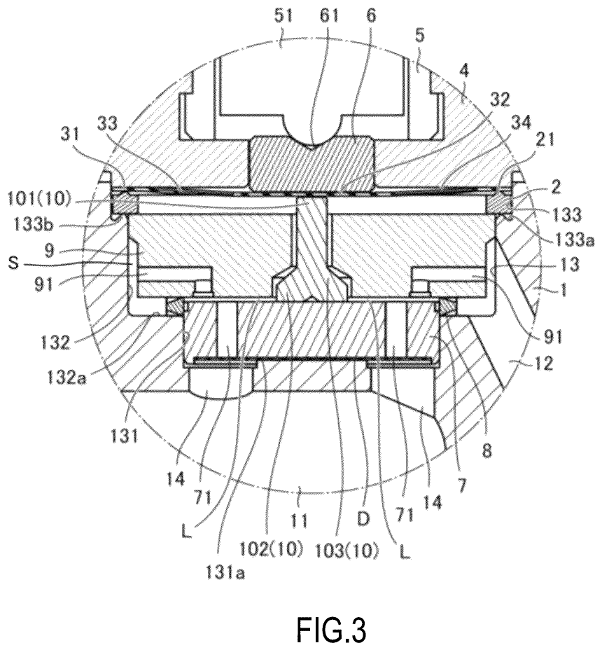

FIG. 1 is a diagram illustrating the valve 100 according to the present embodiment. In FIG. 1, an actuator 5 is not illustrated in a cross section, and components other than the actuator 5 are illustrated in cross sections. FIG. 2 is an enlarged view illustrating a part A in FIG. 1, and illustrates the valve 100 in a closed state. FIG. 3 corresponds to FIG. 2, and illustrates the valve 100 in an open state.

As illustrated in FIG. 1, the valve 100 according to the present embodiment is provided in a fluid control device (not illustrated) used as a unit of supplying a process gas as a fluid in a semiconductor manufacturing device (CVD device, sputtering device, etching device, and the like (not illustrated)) used in the manufacture of semiconductors.

As illustrated in FIGS. 1 to 3, the valve 100 includes a flow path block 1, a ring-shaped (specifically, circular ring-shaped) gasket 2 serving as a sealing member which is a first clamping member, a flat plate-shaped diaphragm 3 serving as a diaphragm, a bonnet 4 which is a second clamping member, an actuator 5, a columnar (specifically, circular columnar) diaphragm presser 6, a dome-shaped disc spring D serving as a biasing member, a columnar (specifically, circular columnar) poppet 7, a ring-shaped (specifically, circular ring-shaped) inner gasket 8, a tubular (specifically, cylindrical) orifice 9, and a push rod 10.

The flow path block 1 has an inlet flow path 11 through which a process gas or a purge gas serving as a fluid flows in, an outlet flow path 12 through which the process gas or the purge gas flows out, and a recess portion 13 communicating one end of the inlet flow path 11 to one end of the outlet flow path 12.

The inlet flow path 11 extends along a horizontal direction from a left side surface serving as one side surface of the flow path block 1 to a right side surface serving as the other side surface of the flow path block 1. The inlet flow path 11 is formed such that one end thereof is located below the recess portion 13. A plurality of (for example, two) connection flow paths 14 for communicating one end of the inlet flow path 11 and the recess portion 13 are formed between the one end of the inlet flow path 11 and the recess portion 13. Furthermore, the inlet flow path 11 is formed such that the other end thereof opens on the left side surface of the flow path block 1.

The outlet flow path 12 inclines from a side surface of the recess portion 13 (specifically, a side surface of a medium diameter recess portion 132 described later) toward a lower end surface serving as the other end surface of the flow path block 1. The outlet flow path 12 is formed such that one end thereof communicates with the recess portion 13 on the side surface of the recess portion 13. Furthermore, the outlet flow path 12 is formed such that the other end thereof opens on the lower end surface of the flow path block 1.

The gasket 2, the diaphragm 3, the disc spring D, the poppet 7, the inner gasket 8, the orifice 9, and the push rod 10 are housed in the recess portion 13 so as to be coaxially formed.

The recess portion 13 is formed on an upper end surface serving as one end surface of the flow path block 1. As illustrated in FIG. 2 and FIG. 3, the recess portion 13 has a small diameter recess portion 131 (specifically, the circular ring-shape small diameter recess portion 131 in a plan view) communicating with the plurality of connection flow paths 14, a medium diameter recess portion 132 (specifically, the circular ring-shaped medium diameter recess portion 132 in a plan view) connected to an upper end of the small diameter recess portion 131 and having a diameter larger than the diameter of the small diameter recess portion 131, and a large diameter recess portion 133 (specifically, the circular ring-shaped large diameter recess portion 133 in a plan view) connected to an upper end of the medium diameter recess portion 132 and having a diameter larger than the diameter of the medium diameter recess portion 132. The small diameter recess portion 131, the medium diameter recess portion 132, and the large diameter recess portion 133 are formed coaxially.

The small diameter recess portion 131 has a small diameter recess portion bottom 131a (that is, bottom of the recess portion 13) serving as a first mounting portion on which the disc spring D is mounted. The medium diameter recess portion 132 is connected to the upper end of the small diameter recess portion 131 and has a ring-shaped (specifically, circular ring-shaped) medium diameter recess portion bottom 132a serving as a second mounting portion on which the inner gasket 8 is mounted. The large diameter recess portion 133 has a ring-shaped (specifically, circular ring-shaped) large diameter recess portion bottom 133a connected to the upper end of the medium diameter recess portion 132 and a ring-shaped (specifically, circular ring-shaped) protrusion 133b protruding from an inner peripheral edge of the large diameter recess portion bottom 133a and serving as a third mounting portion on which the gasket 2 is mounted.

In the present embodiment, one end of the inlet flow path 11 and one end of the outlet flow path 12 are formed to open below the recess portion 13 and open in the side surface of the recess portion 13, respectively, but the present invention is not limited thereto, and for example, one end of the inlet flow path 11 and the one end of the outlet flow path 12 may be located on the side surface of the recess portion 13 and below the recess portion 13, respectively. That is, the disposing of the inlet flow path 11 and the outlet flow path 12 may be interchanged.

The gasket 2 is housed in the large diameter recess portion 133 so as to be mounted on the protrusion 133b. The gasket 2 has a gasket protrusion 21 protruding from a side opposite to the protrusion 133b of the gasket 2. The gasket 2 is formed to have an inner diameter smaller than the diameter of the medium diameter recess portion 132.

The diaphragm 3 is housed in the large diameter recess portion 133 such that a peripheral edge portion 31 to be described later comes into contact with the gasket protrusion 21 of the gasket 2 and is mounted on the gasket 2. The diaphragm 3 is formed in an elastically deformable manner. Details of the diaphragm 3 will be described later.

The bonnet 4 is fixed to the flow path block 1, for example, by a bolt (not illustrated) so that the peripheral edge portion 31 of the diaphragm 3 is pressed against the gasket protrusion 21 of the gasket 2. That is, in a state where the bonnet 4 is fixed to the flow path block 1, the diaphragm 3 is sandwiched between the gasket protrusion 21 of the gasket 2 and the bonnet 4.

The bonnet 4 is formed in a substantially tubular shape (specifically, a substantially cylindrical shape). A lower end surface of the bonnet 4 is flush. The bonnet 4 has a large diameter portion 41 formed on an inner peripheral side of the bonnet 4 and at an upper side serving as one end of the bonnet 4, and a small diameter portion 42 formed on the inner peripheral side of the bonnet 4 and at a lower side serving as the other end of the bonnet 4.

A lower end serving as one end of the actuator 5 is screwed into the large diameter portion 41. The small diameter portion 42 houses the diaphragm presser 6. The large diameter portion 41 and the small diameter portion 42 are formed coaxially so as to communicate with each other.

As illustrated in FIG. 1, the actuator 5 is provided on the bonnet 4 so as to press down the diaphragm 3 via the diaphragm presser 6. The actuator 5 is a piezoelectric actuator having a piezoelectric element 51. By applying a voltage to the piezoelectric element 51, the piezoelectric element 51 expands, and a convex portion 511 serving as a tip end of the piezoelectric element 51 presses the diaphragm presser 6 toward the diaphragm 3 (that is, downward). A detailed description of the actuator 5 is omitted.

In the present embodiment, the actuator 5 is implemented by the piezoelectric actuator having the piezoelectric element 51, but is not limited thereto, and may be implemented by, for example, an air actuator having a cylinder and a piston.

The diaphragm presser 6 is housed in the small diameter portion 42 of the bonnet 4 so as to be sandwiched between the convex portion 511 of the piezoelectric element 51 and the diaphragm 3. An upper end surface serving as a surface of the diaphragm presser 6 facing the piezoelectric element 51 has a V-shaped recess 61 that comes into contact with the convex portion 511. A lower end surface serving as a surface of the diaphragm presser 6 facing the diaphragm 3 is flush.

The disc spring D is housed in the small diameter recess portion 131 so as to be mounted on the small diameter recess portion bottom 131a. In the present embodiment, the disc spring D is housed in the small diameter recess portion 131 such that a convex surface comes into contact with the small diameter recess portion bottom 131a, but is not limited thereto, and for example, the disc spring D may be housed in the small diameter recess portion 131 such that the convex surface abuts aganist the poppet 7.

In the present embodiment, the biasing member is implemented by the disc spring D, but is not limited thereto, and may be implemented by, for example, a coil spring.

The poppet 7 is housed in the small diameter recess portion 131 so as to be mounted on the small diameter recess portion bottom 131a via the disc spring D. The poppet 7 is provided such that an upper end serving as one end of the poppet 7 enters the medium diameter recess portion 132. The disc spring D is provided at a lower end serving as the other end of the poppet 7. Specifically, a peripheral edge portion of the disc spring D is fitted to the lower end of the poppet 7.

The poppet 7 is provided with a plurality of (for example, two) poppet flow paths 71 that penetrate along a thickness direction so as to communicate an upper end surface and a lower end surface. The plurality of poppet flow paths 71 are formed such that each of lower ends serving as one end of each of the poppet flow paths 71 communicates with each of the plurality of connection flow paths 14. That is, each of the plurality of poppet flow paths 71 is connected to one end of the inlet flow path 11 through each of the plurality of connection flow paths 14. Each of the plurality of poppet flow paths 71 is also formed such that an upper end serving as the other end of the poppet flow path 71 communicates with the medium diameter recess portion 132.

The inner gasket 8 is housed in the medium diameter recess portion 132 so as to be located on an outer peripheral side of the poppet 7 and mounted on the medium diameter recess portion bottom 132a. In this state, an inner peripheral surface of the inner gasket 8 and an outer peripheral surface of the poppet 7 are in contact with each other. Accordingly, the inner gasket 8 is positioned such that displacement (movement) toward a radial direction is restricted.

The orifice 9 is housed in the medium diameter recess portion 132 so as to be sandwiched between the gasket 2 (specifically, a part of the gasket 2 located on an inner peripheral side of the large diameter recess portion bottom 133a) and the inner gasket 8.

In a cross-sectional view, a plurality of (for example, two) L-shaped orifice flow paths 91 are formed in the orifice 9. In each of the orifice flow paths 91, a lower end serving as one end opens to a lower end surface serving as an end surface of the orifice 9 facing the inner gasket 8, and the other end opens to an outer peripheral surface of the orifice 9. A clearance S is formed between the outer peripheral surface of the orifice 9 and a side surface of the medium diameter recess portion 132. The other end of each of the plurality of the orifice flow paths 91 communicates with one end of the outlet flow path 12 through the clearance S. The poppet flow path 71 and the orifice flow path 91 are configured such that the upper end of the poppet flow path 71 and one end of the orifice flow path 91 are offset from each other. The inner gasket 8 seals the inlet flow path 11 and the clearance S.

The push rod 10 is housed in the recess portion 13 (specifically, both the medium diameter recess portion 132 and the large diameter recess portion 133) so as to sandwich the diaphragm 3 together with the diaphragm presser 6. The push rod 10 is provided between the diaphragm 3 and the poppet 7 to pass through the orifice 9 and be located on an inner peripheral side of the orifice 9. The push rod 10 may be in contact with both the diaphragm 3 and the poppet 7. The push rod 10 may be in contact with any one of the diaphragm 3 and the poppet 7, and a gap may be formed between the other one and the push rod 10. The gap may be formed between the push rod 10 and the diaphragm 3 and between the push rod 10 and the poppet 7. In either state, it can be said that the push rod 10 sandwiches the diaphragm 3 together with the diaphragm presser 6.

The push rod 10 has a small diameter rod portion 101 serving as a diaphragm contact portion that is capable of coming into contact with the diaphragm 3, a large diameter rod portion 102 that has a diameter larger than a diameter of the small diameter rod portion 101 and is capable of coming into contact with the poppet 7, and an enlarged diameter rod portion 103 that connects the small diameter rod portion 101 and the large diameter rod portion 102 and has a diameter gradually increasing from a small diameter rod portion 101 side toward a large diameter rod portion 102 side. The diameter of the small diameter rod portion 101 is formed smaller than a diameter of the diaphragm presser 6. An upper end surface of the small diameter rod portion 101 is flush.

### Operation of Valve

Next, an operation of the valve 100 will be described with reference to FIGS. 2 and 3.

In the valve 100 configured as described above, when the voltage is applied to the piezoelectric element 51 of the actuator 5, as illustrated in FIG. 3, the piezoelectric element 51 expands, and the convex portion 511 of the piezoelectric element 51 presses the diaphragm presser 6. In this case, the diaphragm 3 is pressed by the diaphragm presser 6 and bends (that is, elastically deforms). In this case, the push rod 10 moves toward the poppet 7 due to the bending of the diaphragm 3. Then, the poppet 7 is pressed down by the push rod 10 against a biasing force of the disc spring D, and a relay flow path L is formed between the orifice 9 (specifically, an upper end surface of the orifice 9) and the poppet 7 (specifically, the lower end surface of the poppet 7). In this case, the valve 100 is in an open state.

The relay flow path L is a flow path that communicates the poppet flow path 71 (specifically, the upper end of the poppet flow path 71) and the orifice flow path 91 (specifically, the lower end of the orifice flow path 91). A communication flow path that communicates one end of the inlet flow path 11 and one end of the outlet flow path 12 includes the poppet flow path 71, the relay flow path L, and the orifice flow path 91, which are formed in this order from an upstream side to a downstream side. In other words, the relay flow path L constitutes a part of the communication flow path. Note that the larger the amount of depression of the poppet 7, the larger a width and the larger a volume of the relay flow path L.

On the other hand, when the voltage is not applied to the piezoelectric element 51 of the actuator 5, as illustrated in FIG. 2, the piezoelectric element 51 does not expand, and the convex portion 511 of the piezoelectric element 51 does not press the diaphragm presser 6. In this case, the diaphragm 3 is not pressed by the diaphragm presser 6 and remains a flat plate shape (that is, does not elastically deform). In this case, the poppet 7 is not pressed down by the push rod 10, but is biased by the disc spring D, and the orifice 9 (specifically, the upper end surface of the orifice 9) and the poppet 7 (specifically, the lower end surface of the poppet 7) come into close contact with each other, and no relay flow path L (see FIG. 3) is present therebetween. In this case, the valve 100 is in a closed state.

### Configuration of Diaphragm

Next, the diaphragm 3 according to the present embodiment will be described in detail with reference to FIGS. 2 to 7.

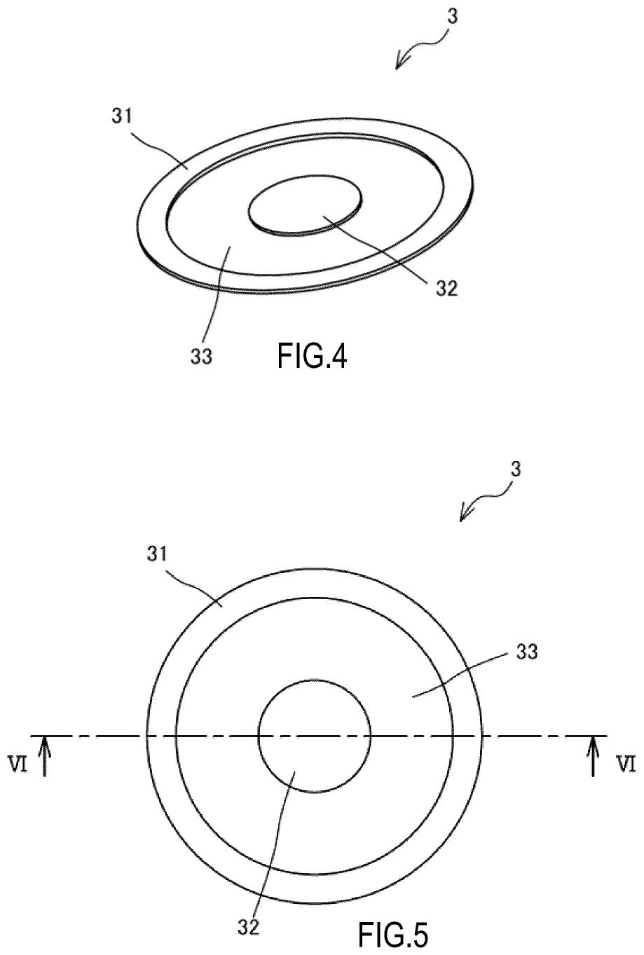

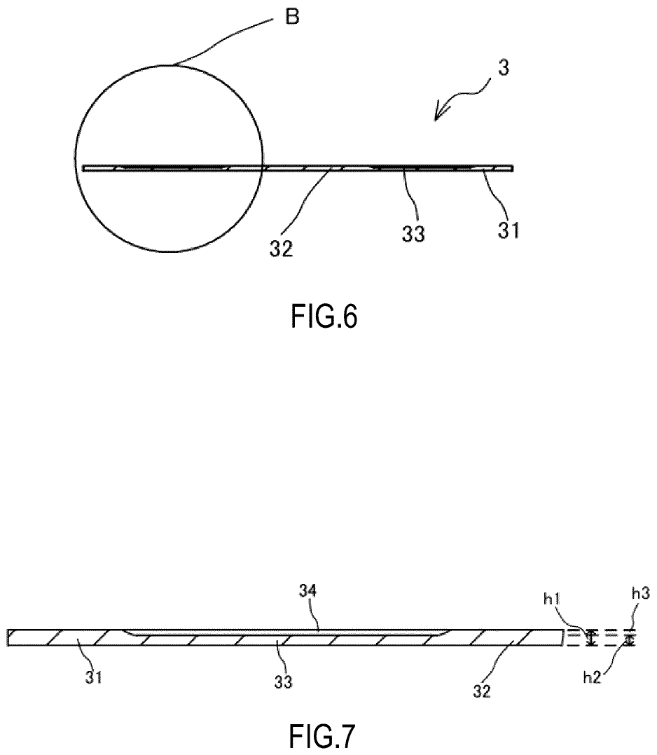

FIG. 4 is a perspective view illustrating the diaphragm 3 according to the present embodiment. FIG. 5 is a plan view illustrating the diaphragm 3 according to the present embodiment. FIG. 6 is a cross-sectional view taken along a line VI-VI in FIG. 5. FIG. 7 is an enlarged view illustrating a part B in FIG. 6.

As illustrated in FIGS. 2 to 7, the diaphragm 3 according to the present embodiment is a stainless steel diaphragm that controls a flow rate of a process gas or a purge gas flowing from the inlet flow path 11 to the outlet flow path 12. The diaphragm 3 includes the ring-shaped (specifically, circular ring-shaped) peripheral edge portion 31, the circular pressed portion 32 located on the inner peripheral side of the peripheral edge portion 31 so as to be pressed by the diaphragm presser 6, and the ring-shaped (specifically, circular ring-shaped) elastic deformation portion 33 located between the peripheral edge portion 31 and the pressed portion 32 so as to elastically deform when the pressed portion 32 is pressed by the diaphragm presser 6. The peripheral edge portion 31, the pressed portion 32, and the elastic deformation portion 33 are formed coaxially.

The peripheral edge portion 31 is sandwiched between the gasket protrusion 21 of the gasket 2 and the lower end surface of the bonnet 4. The peripheral edge portion 31, the gasket 2, and the bonnet 4 are formed coaxially. A width of the peripheral edge portion 31 (that is, a distance from an outer peripheral surface of the peripheral edge portion 31 to an inner peripheral surface of the peripheral edge portion 31) is larger than a width of the gasket protrusion 21, and the gasket protrusion 21 is located between the outer peripheral surface of the peripheral edge portion 31 and the inner peripheral surface of the peripheral edge portion 31. Accordingly, it is possible to prevent the pressed portion 32 from being pressed by the gasket protrusion 21.

A uniform thickness h1 (for example, 0.3 mm) of the peripheral edge portion 31 is also formed. By making the thickness of the peripheral edge portion 31 sandwiched between the gasket protrusion 21 and the lower end surface of the bonnet 4 uniform in this way, sealing performance of the valve 100 can be improved compared to a diaphragm having a peripheral edge portion with a non-uniform thickness.

The pressed portion 32 is sandwiched between the diaphragm presser 6 and the push rod 10. The pressed portion 32 may be in contact with both the diaphragm presser 6 and the push rod 10. The pressed portion 32 may be in contact with the diaphragm presser 6, and a gap may be formed between the pressed portion 32 and the push rod 10. In any state, it can be said that the pressed portion 32 is sandwiched between the diaphragm presser 6 and the push rod 10 (specifically, the small diameter rod portion 101 of the push rod 10). The pressed portion 32, the diaphragm presser 6, and the push rod 10 are formed coaxially. A diameter of the pressed portion 32 is formed larger than the diameters of the diaphragm presser 6 and the small diameter rod portion 101. In other words, the diaphragm presser 6 and the small diameter rod portion 101 are located inside an outer peripheral edge of the pressed portion 32 in a plan view. Accordingly, when the voltage is applied to the piezoelectric element 51, the diaphragm presser 6 can press only the pressed portion 32, not both the pressed portion 32 and the elastic deformation portion 33.

Furthermore, the uniform thickness h1 of the pressed portion 32 is also formed, similar to the peripheral edge portion 31. In the present embodiment, an upper surface serving as one side surface of the peripheral edge portion 31 and an upper surface serving as one side surface of the pressed portion 32 are flush. Similarly, a lower surface serving as the other side surface of the peripheral edge portion 31 and a lower surface serving as the other side surface of the pressed portion 32 are flush. When the valve 100 is in the closed state, the upper surface of the pressed portion 32 is in contact with both the lower end surface of the diaphragm presser 6 and the lower end surface of the bonnet 4.

In the present embodiment, the pressed portion 32 has the same thickness as the thickness h1 of the peripheral edge portion 31, but is not limited thereto, and may have a thickness larger than the thickness h1 of the peripheral edge portion 31, for example. In this case, durability of the pressed portion 32 can be improved, and thus the pressed portion 32 is less likely to elastically deform even when the pressed portion 32 is pressed by the diaphragm presser 6, and performance of transmitting a pressing force from the diaphragm presser 6 to the push rod 10 via the diaphragm 3 (specifically, the pressed portion 32) (hereinafter, also simply referred to as force transmission performance) can be improved.

The elastic deformation portion 33 is a ring-shaped (specifically, circular ring-shaped) thin portion formed between the peripheral edge portion 31 and the pressed portion 32. A ring-shaped (specifically, circular ring-shaped) recessed groove 34 is located above the elastic deformation portion 33. The recessed groove 34 is formed on an upper surface serving as one side surface of the diaphragm 3 so as to be located between the peripheral edge portion 31 and the pressed portion 32. In the present embodiment, the recessed groove 34 is formed to face the bonnet 4. Therefore, the elastic deformation portion 33 is not in contact with the lower end surface of the bonnet 4. The recessed groove 34 is formed by etching, and thus, in a cross-sectional view, an R surface is formed between a bottom wall of the recessed groove 34 (that is, an upper surface serving as one side surface of the elastic deformation portion 33) and a side wall of the recessed groove 34 (that is, a side wall of the peripheral edge portion 31 or a side wall of the pressed portion 32) (that is, at a boundary between the elastic deformation portion 33 and the peripheral edge portion 31 or at a boundary between the elastic deformation portion 33 and the pressed portion 32). Accordingly, a stress at the boundary between the elastic deformation portion 33 and the peripheral edge portion 31 or at the boundary between the elastic deformation portion 33 and the pressed portion 32 is mitigated, and the durability of the diaphragm 3 can be improved. In addition, the elastic deformation portion 33 is formed to be adjacent to both the peripheral edge portion 31 and the pressed portion 32.

The elastic deformation portion 33 has a uniform thickness h2 (for example, 0.2 mm) smaller than the thickness h1. That is, the elastic deformation portion 33 is formed to have the thickness h2 smaller than the thicknesses h1 of the peripheral edge portion 31 and the pressed portion 32. Accordingly, when the pressed portion 32 is pressed by the diaphragm presser 6, the elastic deformation portion 33 that is not pressed by the diaphragm presser 6 is more likely to elastically deform than the elastic deformation portion having the uniform thickness h1, and springiness of the elastic deformation portion 33 can be improved. Furthermore, in other words, by making the thickness h1 of the pressed portion 32 larger than the thickness h2 of the elastic deformation portion 33, the force transmission performance can be improved compared to the pressed portion having the uniform thickness h2.

By making the thickness h2 of the elastic deformation portion 33 larger than a thickness h3 (that is, 0.1 mm) of the recessed groove 34, it is possible to improve both the durability and the springiness of the elastic deformation portion 33 compared to a case where the thickness of the elastic deformation portion 33 is smaller than the thickness of the recessed groove 34.

The diaphragm 3 configured as described above includes the peripheral edge portion 31, the pressed portion 32, and the elastic deformation portion 33, and the elastic deformation portion 33 is formed to have the thickness h2 smaller than the thicknesses h1 of the peripheral edge portion 31 and the pressed portion 32, and thus, the sealing performance, the force transmission performance, and the springiness of the diaphragm 3 can be improved. As a result, it is possible to provide the diaphragm 3 that is excellent in the sealing performance, the force transmission performance, and the springiness.

### Method for Manufacturing Diaphragm

Next, a method for manufacturing the diaphragm 3 according to the present embodiment will be described.

The method for manufacturing the diaphragm 3 includes the following steps S1 to S3.

In step S1, a stainless steel plate-shaped substrate having the uniform thickness h1 is prepared.

Next, in step S2, a ring-shaped (specifically, circular ring-shaped) peripheral edge portion region corresponding to the peripheral edge portion 31 (see FIGS. 5 to 7) in the plate-shaped substrate and a circular pressed portion region corresponding to the pressed portion 32 (see FIGS. 5 to 7) in the plate-shaped substrate are masked. In the present embodiment, in step S2, only an upper surface serving as one side surface of the plate-shaped substrate is masked.

Next, in step S3, a ring-shaped (specifically, circular ring-shaped) elastic deformation portion region corresponding to the elastic deformation portion 33 (see FIGS. 5 to 7) of the plate-shaped substrate is etched (that is, half-etched) to form the elastic deformation portion 33. Specifically, in step S3, liquid-phase etching is performed on the unmasked elastic deformation portion region, so that the elastic deformation portion 33 (thin portion) and the recessed groove 34 (see FIGS. 5 to 7) can be formed in the elastic deformation portion region.

In this way, since the recessed groove 34 is formed by etching, it can be easier to form the R surface at the boundary between the elastic deformation portion 33 and the peripheral edge portion 31 or at the boundary between the elastic deformation portion 33 and the pressed portion 32, compared to a diaphragm in which the recessed groove is formed by pressing. As a result, the stress at the boundary between the elastic deformation portion 33 and the peripheral edge portion 31 or at the boundary between the elastic deformation portion 33 and the pressed portion 32 is mitigated, and the durability of the diaphragm 3 can be improved.

When the diaphragm formed by pressing is compared to the diaphragm 3 formed by etching, these two diaphragms are different in the following points. By performing the pressing, an internal stress during the manufacturing step is generated, and thus, durability may be affected, whereas by performing the etching, the internal stress during the manufacturing step is not generated, and thus, there is no possibility to affect the durability. Therefore, the diaphragm 3 formed by etching is considered to have excellent durability.

### Operation and Effects

Next, operation and effects of the embodiments described above will be described.

The flat plate-shaped diaphragm 3 according to the present embodiment includes the ring-shaped peripheral edge portion 31 having a uniform thickness, the pressed portion 32 located on the inner peripheral side of the peripheral edge portion 31 so as to be pressed, and the elastic deformation portion 33 located between the peripheral edge portion 31 and the pressed portion 32 so as to elastically deform when the pressed portion 32 is pressed, and the elastic deformation portion 33 is formed to have the thickness smaller than the thicknesses of the peripheral edge portion 31 and the pressed portion 32.

In the present embodiment, the elastic deformation portion 33 is a ring-shaped thin portion formed between the peripheral edge portion 31 and the pressed portion 32.

In the present embodiment, the ring-shaped thin portion is formed to be adjacent to both the peripheral edge portion 31 and the pressed portion 32.

In the present embodiment, the elastic deformation portion 33 is not pressed when the pressed portion 32 is pressed.

The valve 100 according to the present embodiment includes the flow path block 1 in which the inlet flow path 11, the outlet flow path 12, and the recess portion 13 that communicates one end of the inlet flow path 11 and one end of the outlet flow path 12 are formed; the ring-shaped gasket 2 housed in the recess portion 13 of the flow path block 1; the diaphragm 3 housed in the recess portion 13 such that only the peripheral edge portion 31 is in contact with the gasket 2; the diaphragm presser 6 configured to press only the pressed portion 32 of the diaphragm 3; the bonnet 4 fixed to the flow path block 1 so as to press the peripheral edge portion 31 of the diaphragm 3 against the gasket 2; the actuator 5 provided on the bonnet 4 so as to press the diaphragm 3 via the diaphragm presser 6; the push rod 10 housed in the recess portion 13 so as to sandwich the pressed portion 32 of the diaphragm 3 together with the diaphragm presser 6; and the relay flow path L constituting the communication flow path for communicating the one end of the inlet flow path 11 with the one end of the outlet flow path 12 in the open state, and configured to increase in the width when the push rod 10 is pressed by pressing down on the diaphragm 3.

In the present embodiment, the valve 100 further includes the plate-shaped poppet 7 including the poppet flow path 71 formed for communicating with one end of the inlet flow path 11, and housed in the recess portion 13 so as to be mounted on the bottom of the recess portion 13 via the disc spring D; the ring-shaped inner gasket 8 housed in the recess portion 13 to be located on the outer peripheral side of the poppet 7; and the tubular orifice 9 having the orifice flow path 91 formed for communicating with the one end of the outlet flow path 12, and housed in the recess portion 13 to be sandwiched between the gasket 2 and the inner gasket 8. The push rod 10 penetrates the orifice 9 so as to be located between the pressed portion 32 of the diaphragm 3 and the poppet 7, when the poppet 7 is pressed down by the push rod 10 against the biasing force of the disc spring D, the width of the relay flow path L formed between the orifice 9 and the poppet 7 and communicating the poppet flow path 71 with the orifice flow path 72 increases, and when the poppet 7 is not pressed down by the push rod 10 and is biased by the disc spring D, the orifice 9 and the poppet 7 come into close contact with each other, and the relay flow path L is not present therebetween.

According to these configurations, by making the thickness of the peripheral edge portion 31 sandwiched between the gasket protrusion 21 and the lower end surface of the bonnet 4 uniform, the sealing performance of the valve 100 can be improved compared to a diaphragm having a peripheral edge portion with a non-uniform thickness. By making the thickness of the elastic deformation portion 33 smaller than the thicknesses of the peripheral edge portion 31 and the pressed portion 32, when the pressed portion 32 is pressed by the diaphragm presser 6, the elastic deformation portion 33 that is not pressed by the diaphragm presser 6 is more likely to elastically deform than the elastic deformation portion having the uniform thickness h1, and the springiness of the elastic deformation portion 33 can be improved. Furthermore, by making the thickness h1 of the pressed portion 32 larger than the thickness h2 of the elastic deformation portion 33, the force transmission performance can be improved compared to the pressed portion having the uniform thickness h2. Accordingly, it is possible to provide the diaphragm 3 that is excellent in the sealing performance, the force transmission performance, and the springiness, the valve 100 including the diaphragm 3, and the method for manufacturing the diaphragm 3.

The method for manufacturing the diaphragm 3 according to the present embodiment includes the step S1 of preparing the plate-shaped substrate having the uniform thickness, the step S2 of masking the peripheral edge portion region corresponding to the peripheral edge portion 31 in the plate-shaped substrate and the pressed portion region corresponding to the pressed portion 32 in the plate-shaped substrate; and the step S3 of etching the elastic deformation portion region corresponding to the elastic deformation portion 33 in the plate-shaped substrate to form the elastic deformation portion 33.

According to this configuration, it can be easier to form the R surface at the boundary between the elastic deformation portion 33 and the peripheral edge portion 31 or at the boundary between the elastic deformation portion 33 and the pressed portion 32, compared to the diaphragm formed by pressing. As a result, the stress at the boundary between the elastic deformation portion 33 and the peripheral edge portion 31 or at the boundary between the elastic deformation portion 33 and the pressed portion 32 is mitigated, and the durability of the diaphragm 3 can be improved.

### First Modification of Diaphragm 3

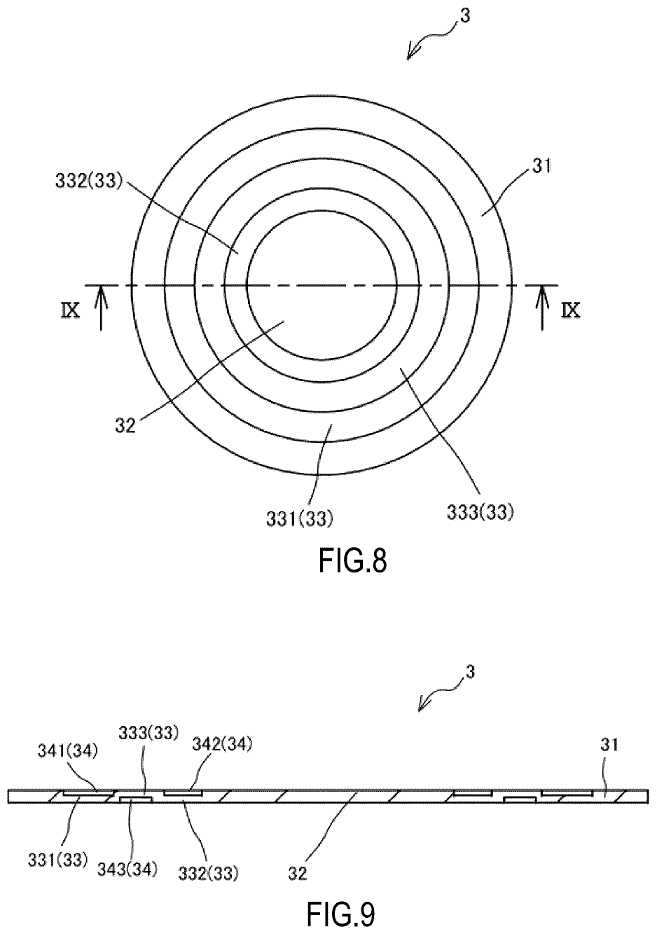

Next, the diaphragm 3 according to a first modification will be described with reference to FIGS. 8 to 9. In the first modification, the description of the same points as those of the embodiment described above will be omitted, and differences from the embodiment described above will be mainly described.

FIG. 8 is a plan view illustrating the diaphragm 3 according to the first modification. FIG. 9 is a cross-sectional view taken along a line IX-IX in FIG. 8.

In the present embodiment described above, the elastic deformation portion 33 includes the ring-shaped thin portion implemented by the ring-shaped recessed groove 34 formed between the peripheral edge portion 31 and the pressed portion 32, but the elastic deformation portion 32 is not limited thereto, and may include a plurality of connected thin portions 331, 332, and 333, as illustrated in FIGS. 8 and 9.

In this case, as illustrated in FIGS. 8 and 9, the elastic deformation portion 33 according to the first modification has a ring-shaped (specifically, circular ring-shaped) first thin portion 331 formed adjacent to the peripheral edge portion 31, a ring-shaped (specifically, circular ring-shaped) second thin portion 332 formed adjacent to the pressed portion 32, and a ring-shaped (specifically, circular ring-shaped) third thin portion 333 formed adjacent to both the first thin portion 331 and the second thin portion 332. It is preferable that the first thin portion 331, the second thin portion 332, and the third thin portion 333 each have a uniform thickness.

The first thin portion 331 is implemented by a ring-shaped (specifically, circular ring-shaped) first recessed groove 341 formed on the upper surface of the diaphragm 3. The second thin portion 332 is implemented by a ring-shaped (specifically, circular ring-shaped) second recessed groove 342 formed on the upper surface of the diaphragm 3. The third thin portion 333 is implemented by a ring-shaped (specifically, circular ring-shaped) third recessed groove 343 formed on a lower surface of the diaphragm 3. The first recessed groove 341, the second recessed groove 342, and the third recessed groove 343 are formed by etching.

Accordingly, the recessed grooves 34 for forming the thin portions can be formed not only on one side surface of the diaphragm 3, but also on both side surfaces of the diaphragm 3.

In this way, in the first modification, the elastic deformation portion 33 is formed in a substantially wave shape including the first thin portion 331, the second thin portion 332, and the third thin portion 333, so that it is possible to ensure the durability of the elastic deformation portion 33 while further improving the springiness of the elastic deformation portion 33.

### Second Modification of Diaphragm 3

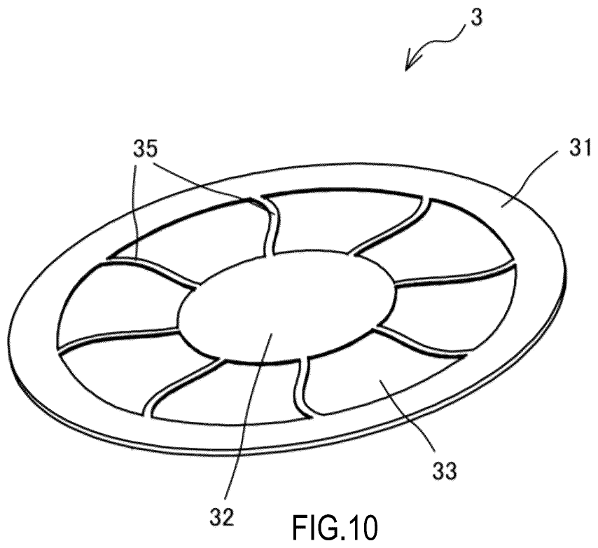

Next, the diaphragm 3 according to a second modification will be described with reference to FIG. 10. In the second modification, the description of the same points as those of the embodiment described above and the first modification will be omitted, and differences from the embodiment described above and the first modification will be mainly described.

FIG. 10 is a perspective view illustrating the diaphragm 3 according to the second modification.

In the above embodiment, the diaphragm 3 includes the peripheral edge portion 31, the pressed portion 32, and the elastic deformation portion 33, whereas in the second modification, as illustrated in FIG. 10, the diaphragm 3 includes a plurality of bridge portions 35 serving as rib portions, in addition to the peripheral edge portion 31, the pressed portion 32, and the elastic deformation portion 33 according to the embodiment described above.

In the second modification, as illustrated in FIG. 10, the plurality of (for example, four) bridge portions 35 are formed at equal intervals in a circumferential direction to connect the peripheral edge portion 31 and the pressed portion 32 and extend radially. By including such bridge portions 35, the diaphragm 3 can improve the springiness of the elastic deformation portion 33 while further ensuring the durability of the elastic deformation portion 33.

It is preferable that a total thickness of the elastic deformation portion 33 and the bridge portions 35 is the thicknesses of the peripheral edge portion 31 and the pressed portion 32.

In the second modification, each of the plurality of bridge portions 35 is formed in a curved shape, but is not limited thereto, and for example, may be formed in a straight line.

In the second modification, the rib portion includes the plurality of bridge portions 35 connecting the peripheral edge portion 31 and the pressed portion 32, but is not limited thereto, and for example, the rib portion may be implemented by a ring-shaped portion formed within the elastic deformation portion 33.

Although the embodiment of the present invention has been described above, the above embodiment merely exemplifies application examples of the present invention and does not intend to limit the technical scope of the present invention to the specific configurations of the above embodiment.

The present application claims a priority of Japanese Patent Application No. 2023-074608 filed with the Japan Patent Office on Apr. 28, 2023, all the contents of which are hereby incorporated by reference.

1. A flat plate-shaped diaphragm comprising:
a ring-shaped peripheral edge portion having a uniform thickness;
a pressed portion located on an inner peripheral side of the peripheral edge portion so as to be pressed; and
an elastic deformation portion located between the peripheral edge portion and the pressed portion so as to elastically deform when the pressed portion is pressed, wherein
the elastic deformation portion is formed to have a thickness smaller than thicknesses of the peripheral edge portion and the pressed portion.

2. The diaphragm according to claim 1, wherein
the elastic deformation portion is a ring-shaped thin portion formed between the peripheral edge portion and the pressed portion.

3. The diaphragm according to claim 2, wherein
the ring-shaped thin portion is formed to be adjacent to both the peripheral edge portion and the pressed portion.

4. The diaphragm according to claim 1, wherein
the elastic deformation portion is not pressed when the pressed portion is pressed.

5. A valve comprising:
a flow path block in which an inlet flow path, an outlet flow path, and a recess portion that communicates one end of the inlet flow path with one end of the outlet flow path are formed;
a ring-shaped sealing member housed in the recess portion of the flow path block;
the diaphragm according to claim 1 housed in the recess portion such that only the peripheral edge portion is in contact with the sealing member;
a diaphragm presser configured to press only the pressed portion of the diaphragm;
a bonnet fixed to the flow path block so as to press the peripheral edge portion of the diaphragm against the sealing member;
an actuator provided on the bonnet so as to press the diaphragm via the diaphragm presser;
a push rod housed in the recess portion so as to sandwich the pressed portion of the diaphragm together with the diaphragm presser; and
a relay flow path constituting a communication flow path for communicating the one end of the inlet flow path with the one end of the outlet flow path in an open state, and configured to increase in a width when the push rod is pressed by pressing down on the diaphragm.

6. The valve according to claim 5, further comprising:
a plate-shaped poppet including a poppet flow path formed for communicating with either the one end of the inlet flow path or the one end of the outlet flow path, and housed in the recess portion so as to be mounted on a bottom of the recess portion via a biasing member;
a ring-shaped inner gasket housed in the recess portion so as to be located on an outer peripheral side of the poppet; and
a tubular orifice having an orifice flow path formed for communicating with the other one of the one end of the inlet flow path or the one end of the outlet flow path, and housed in the recess portion so as to be sandwiched between the sealing member and the inner gasket, wherein
the push rod penetrates the orifice so as to be located between the pressed portion of the diaphragm and the poppet,
when the poppet is pressed down by the push rod against a biasing force of the biasing member, the width of the relay flow path formed between the orifice and the poppet and communicating the poppet flow path and the orifice flow path increases, and
when the poppet is not pressed down by the push rod and is biased by the biasing member, the orifice and the poppet come into close contact with each other, and the relay flow path is not present between the orifice and the poppet.

7. A method for manufacturing the diaphragm according to claim 1, the method comprising:
a step of preparing a plate-shaped substrate having a uniform thickness;
a step of masking a peripheral edge portion region corresponding to the peripheral edge portion in the plate-shaped substrate and a pressed portion region corresponding to the pressed portion in the plate-shaped substrate; and
a step of etching an elastic deformation portion region corresponding to the elastic deformation portion in the plate-shaped substrate to form the elastic deformation portion.
